(19) United States
(12) Patent Application Publication
(10) Pub. No.: US 2004/0186206 A1
(43) Pub. Date: Sep. 23, 2004

(54) Polishing composition

(76) Inventors: Yasuhiro Yoneda, Wakayama-shi (JP); Shigeaki Takashina, Wakayama-shi (JP); Toshiya Hagihara, Wakayama-shi (JP)

Correspondence Address: BIRCH STEWART KOLASCH & BIRCH, PO BOX 747, FALLS CHURCH, VA, 22040-0747, US

(21) Appl. No.: 10/740,458

(22) Filed: Dec. 22, 2003

(30) Foreign Application Priority Data
Dec. 26, 2002 (JP) 2002-376053
Feb. 14, 2003 (JP) 2003-036314

(51) Int. Cl. C08K 5/35

(52) U.S. Cl. 524/95; 524/493; 524/236; 524/107

(57) ABSTRACT

A polishing composition comprising silica particles, polymer particles and a cationic compound in an aqueous medium; a polishing process for a substrate for a precision part with the polishing composition as defined above; a method for planarization of a substrate for a precision part, including the step of polishing the substrate for a precision part with the polishing composition as defined above; and a method for planarization of a substrate for a precision part, including the steps of polishing the substrate for a precision part with the polishing composition as defined above, the polishing composition being a first polishing composition, with applying a polishing load of 50 to 1000 hPa, and polishing the substrate after the first step with a second polishing composition comprising silica particles in an aqueous medium with applying a polishing load of 50 to 1000 hPa. The polishing composition is, for instance, useful in planarization of a semiconductor substrate having a thin film formed on its surface having dents and projections.

### FIELD OF THE INVENTION

The present invention relates to a polishing composition, a polishing process with the polishing composition, a method for planarization of a substrate for a precision part, a method for manufacturing a substrate for a precision part, and a semiconductor device containing the above-mentioned substrate for a precision part. More specifically, the present invention relates to a polishing composition, which is, for instance, useful in planarization of a semiconductor substrate having a thin film formed on its surface having dents and projections, a polishing process including the step of polishing a substrate for a precision part with this polishing composition, a method for planarization of a substrate for a precision part with the above-mentioned polishing composition, a method for manufacturing a substrate for a precision part with the above-mentioned polishing composition, and a semiconductor device containing a substrate for a precision part obtained by the above method for manufacturing a substrate for a precision part.

### BACKGROUND OF THE INVENTION

In an ultra-ultra large scale integrated circuit of the present day, there is a tendency that a transistor and other semiconductor elements are reduced in size, thereby increasing mounting density. Therefore, various microfabrication techniques have been developed. One of the microfabrication techniques includes chemical-mechanical polishing (also simply referred to as “CMP”) technique. The CMP technique is very important technique in the process for manufacturing a semiconductor device, for instance, shallow trench isolation (STI), planarization of interlayer dielectric, formation of embedded metal line, plug formation, formation of embedded capacitor, and the like. Among them, the planarization, serves to reduce a step height of the polishing surface, and is carried out when various metals, dielectrics and the like are laminated, so that the planarization is an important step from the viewpoints of miniaturization and densification of a semiconductor device. Therefore, there has been desired to quickly realize planarization.

As a polishing liquid for CMP usable in the above production steps, a dispersion of abrasive particles in water has been widely used. The silica is widely used as the abrasive particles because of low costs and high purity. However, there arise some problems that the polishing rate is greatly dependent upon the patterns of the dent portions and the projection portions of the surface to be polished, so that the polishing rate of the projection portions greatly varies depending upon the difference in pattern densities or in pattern sizes, and that the polishing is undesirably progressed at projection portions, whereby the planarization cannot be realized at a high level on an entire surface of a wafer.

Japanese Patent Laid-Open Nos. 2001-7061 and 2001-57350 each discloses a polishing agent containing ceria (cerium oxide) particles, a dispersant, and various additives, wherein the projection portions are selectively polished among the dents and the projections existing on a film to be polished, and further the polishing of the dent portions is suppressed, thereby making it possible to achieve global planarization with little pattern dependency. However, there arise some problems that the ceria particles have low dispersion stability in a polishing agent and are easily aggregated, so that scratches are easily generated on the film and the polishing properties are not stabilized. Although various improvements have been tried, those with satisfactory properties have not yet been obtained.

In addition, conventionally, in the production process for a semiconductor device, there has been proposed CMP method using a fumed silica-based or alumina-based polishing liquid for the purpose of forming on a substrate an insulation film made of silicon dioxide or the like formed by plasma-CVD, high-density plasma-CVD, reduced pressure-CVD, spattering, SOD (Spin-On Dielectrics), electric plating or the like, a capacitor having a strong dielectric film, planarization and an embedded layer made of metal line or a metal alloy. However, in the method described above, a so-called “pattern dependency,” wherein the polishing rates are greatly varied depending upon the difference in densities or sizes of the local patterns, is strongly exhibited. Therefore, although the planarization can be carried out on a local level, there arise some problems that the planarization cannot be realized over an entire surface to be polished of the substrate, i.e. a high level of planarization cannot be achieved. Therefore, a technique of adding an etch-back step in which a film to be polished of the projection portions is removed by etching has been widely carried out. However, there arises a problem that the productions steps are increased, thereby increasing the production costs.

Japanese Patent Laid-Open No. 2000-195832 discloses a polishing process including the step of carrying out planarization with inorganic oxide abrasive grains as abrasive grains and adding to the abrasive grains a water-soluble organic polymer, a water-soluble anionic surfactant, a water-soluble nonionic surfactant and a water-soluble amine. However, in a case where silicon oxide particles, i.e. silica particles are used as abrasive grains and further a water-soluble organic polymer as an additive as described in Japanese Patent Laid-Open No. 2000-195832, an effect of increasing the polishing rate is little or the polishing rate is actually lowered, as compared to that of an embodiment of the present invention where polymer particles are dispersed, so that planarization cannot be quickly achieved. Also, Japanese Patent Laid-Open No. 2000-195832 has a main feature of the use of cerium oxide as the abrasive grains, and there are no concrete embodiments for silica particles which give little generation of scratches.

In addition, Japanese Patent Laid-Open No. 2000-204353 discloses an aqueous dispersion for chemical-mechanical polishing containing polymer particles and inorganic particles, and a method for manufacturing a semiconductor device using the aqueous dispersion. However, according to the aqueous dispersion, while the polishing rate is increased, a high level of planarization cannot be achieved.

### SUMMARY OF THE INVENTION

The present invention relates to:

[1] a polishing composition containing silica particles, polymer particles and a cationic compound in an aqueous medium;

[2] a polishing process for a substrate for a precision part, including the step of polishing the substrate for a precision part with the polishing composition as defined in the above [1];

[3] a method for planarization of a substrate for a precision part, including the step of polishing the substrate for a precision part with the polishing composition as defined in the above [1];

[4] a method for planarization of a substrate for a precision part, including the following first step and second step:

first step: polishing the substrate for a precision part with the polishing composition as defined in the above [1], the polishing composition being a first polishing composition, with applying a polishing load of 50 to 1000 hPa; and

second step: polishing the substrate after the first step with a second polishing composition containing silica particles in an aqueous medium with applying a polishing load of 50 to 1000 hPa;

[5] a method for manufacturing a substrate for a precision part, including the step of polishing a substrate for a precision part with the polishing composition of as defined in the above [1];

[6] a method for manufacturing a substrate for a precision part, including the following first step and second step:

first step: polishing the substrate for a precision part with the polishing composition as defined in the above [1], the polishing composition being a first polishing composition, with applying a polishing load of 50 to 1000 hPa; and

second step: polishing the substrate after the first step with a second polishing composition containing silica particles in an aqueous medium with applying a polishing load of 50 to 1000 hPa;

[7] a semiconductor device comprising a substrate for a precision part obtained by the method as defined in the above [5]; and

[8] a semiconductor device comprising a substrate for a precision part obtained by the method as defined in the above [6].

### BRIEF DESCRIPTION OF THE DRAWINGS

FIG. 1 is a graph schematically showing change in polishing rates with respect to polishing load when an object to be polished without having dent and projection patterns is polished with the polishing composition of the present invention, or with a usual silica-based polishing liquid;

FIG. 2 is a schematic view showing each site of the patterned wafer to be determined when the polishing results of the patterned wafer are evaluated in Examples;

FIG. 3 is a graph schematically showing change in polishing rates with respect to polishing load when a blanket wafer is polished with each of the polishing compositions obtained in Example 1 and Comparative Example 1, wherein a solid circle (●) represents Example 1, and an open rhombus (⋄) represents Comparative Example 1;

FIG. 4 is a graph schematically showing change in polishing rates with respect to polishing load when a blanket wafer is polished with each of the polishing compositions obtained in Example 2 and Comparative Example 1, wherein a solid circle (●) represents Example 2, and an open rhombus (⋄) represents Comparative Example 1;

FIG. 5 is a graph schematically showing change in polishing rates with respect to polishing load when a blanket wafer is polished with each of the polishing compositions obtained in Example 3 and Comparative Example 1, wherein a solid circle (●) represents Example 3, and an open rhombus (⋄) represents Comparative Example 1;

FIG. 6 is a graph schematically showing change in polishing rates with respect to polishing load when a blanket wafer is polished with each of the polishing compositions obtained in Example 4 and Comparative Example 1, wherein a solid circle ( ) represents Example 4, and an open rhombus (⋄) represents Comparative Example 1;

FIG. 7 is a graph schematically showing change in polishing rates with respect to polishing load when a blanket wafer is polished with each of the polishing compositions obtained in Example 5 and Comparative Example 1, wherein a solid circle (●) represents Example 5, and an open rhombus (⋄) represents Comparative Example 1;

FIG. 8 is a graph schematically showing change in polishing rates with respect to polishing load when a blanket wafer is polished with each of the polishing compositions obtained in Example 6 and Comparative Example 1, wherein a solid circle (●) represents Example 6, and an open rhombus (⋄) represents Comparative Example 1;

FIG. 9 is a graph schematically showing change in polishing rates with respect to polishing load when a blanket wafer is polished with each of the polishing compositions obtained in Example 7 and Comparative Example 1, wherein a solid circle (●) represents Example 7, and an open rhombus (⋄) represents Comparative Example 1;

FIG. 10 is a graph schematically showing change in polishing rates with respect to polishing load when a blanket wafer is polished with each of the polishing compositions obtained in Example 8 and Comparative Example 3, wherein a solid circle (●) represents Example 8, and an open rhombus (⋄) represents Comparative Example 3;

FIG. 11 is a graph schematically showing change in polishing rates with respect to polishing load when a blanket wafer is polished with each of the polishing compositions obtained in Comparative Examples 1 and 2, wherein an open rhombus (⋄) represents Comparative Example 1, and an open circle (∘) represents Comparative Example 2;

FIG. 12 is a graph schematically showing change in heights from a standard surface with respect to polishing time when a patterned wafer is polished with the polishing composition obtained in Example 1, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 13 is a graph schematically showing change in heights from a standard surface with respect to polishing time when a patterned wafer is polished with the polishing composition obtained in Example 2, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 14 is a graph schematically showing change in heights from a standard surface with respect to polishing time when a patterned wafer is polished with the polishing composition obtained in Example 3, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 15 is a graph schematically showing change in heights from a standard surface with respect to polishing time when a patterned wafer is polished with the polishing composition obtained in Example 4, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 16 is a graph schematically showing change in heights from a standard surface with respect to polishing time when a patterned wafer is polished with the polishing composition obtained in Example 5, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 17 is a graph schematically showing change in heights from a standard surface with respect to polishing time when a patterned wafer is polished with the polishing composition obtained in Example 6, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 18 is a graph schematically showing change in heights from a standard surface with respect to polishing time when a patterned wafer is polished with the polishing composition obtained in Example 7, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 19 is a graph schematically showing change in heights from a standard surface with respect to polishing time when a patterned wafer is polished with the polishing composition obtained in Example 8, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 20 is a graph schematically showing change in heights from a standard surface with respect to polishing time when a patterned wafer is polished with the polishing composition obtained in Comparative Example 1, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 21 is a graph schematically showing change in heights from a standard surface with respect to polishing time when a patterned wafer is polished with the polishing composition obtained in Comparative Example 2, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 22 is a graph schematically showing change in heights from a standard surface with respect to polishing time when a patterned wafer is polished with the polishing composition obtained in Comparative Example 3, wherein an open circle (∘) represents D10 at projection portions, a solid circle (●) represents D10 at dent portions, an open square (□) represents D50 at projection portions, a solid square (▪) represents D50 at dent portions, an open triangle (Δ) represents D90 at projection portions, and a solid triangle (▴) represents D90 at dent portions;

FIG. 23 is a graph showing change in step heights and change in heights from a standard surface at the dent portions and the projections portion after polishing for 1 minute with each of the polishing compositions obtained in Example 9 and Comparative Example 4, wherein the changes after 1 minute of the first polishing step is shown for Example 9, and wherein X represents dent portions for respective D10, D50 and D90, and Y represents projection portions for respective D10, D50 and D90;

FIG. 24 is a graph showing change in step heights and change in heights from a standard surface at the dent portions and the projections portion after polishing for 2 minutes with each of the polishing compositions obtained in Example 9 and Comparative Example 4, wherein the changes after 2 minutes of the first polishing step is shown for Example 9, and wherein X represents dent portions for respective D10, D50 and D90, and Y represents projection portions for respective D10, D50 and D90;

FIG. 25 is a graph showing change in step heights and change in heights from a standard surface at the dent portions and the projections portion after polishing for 3 minutes with each of the polishing compositions obtained in Example 9 and Comparative Example 4, wherein the changes after 3 minutes of the first polishing step is shown for Example 9, and wherein X represents dent portions for respective D10, D50 and D90, and Y represents projection portions for respective D10, D50 and D90; and

FIG. 26 is a graph showing change in step heights and change in heights from a standard surface at the dent portions and the projections portion after polishing for 4 minutes with each of the polishing compositions obtained in Example 9 and Comparative Example 4, wherein the changes after 1 minute of the second polishing step is shown for Example 9, and wherein X represents dent portions for respective D10, D50 and D90, and Y represents projection portions for respective D19, D50 and D90.

The numerals used in the figures are as follows:

1 is a standard surface, 2 is a step height of a substrate, 3 is an initial film thickness at a projection portion, 4 is an initial film thickness at a dent portion, 5 is an initial surface step height, 6 is a silicon substrate, 7 is a TEOS film, 8 is a remaining film thickness at a projection portion, and 9 is a remaining film thickness at a dent portion.

### DETAILED DESCRIPTION OF THE INVENTION

All publications cited herein are hereby incorporated by reference.

The present invention relates to a polishing composition which has some benefits including capability of subjecting a substrate to be polished having dents and projections on its surface to planarization efficiently and at a high level.

The present invention also relates to a polishing process for a substrate for a precision part with the polishing composition and a method for planarization of the substrate for a precision part, which have some benefits including capability of subjecting the substrate to a high level of planarization even when polishing a substrate having a desired thickness, even more preferably a substrate which has a surface on which a thin film is formed, the surface having dents and projections.

The present invention further relates to a method for efficiently manufacturing a substrate for a precision part which is subjected to a high level of planarization, even more preferably a substrate for a precision part having a surface on which a thin film is formed, the thin film having a desired thickness in CMP technique including shallow trench isolation, planarization of interlayer dielectric, formation of embedded metal line, plug formation, or formation of embedded capacitor, and a semiconductor device utilizing the substrate for a precision part obtained by the method for manufacturing the substrate.

These and other advantages of the present invention will be apparent from the following description.

1. Polishing Composition

In the present invention, the above-mentioned silica particles include colloidal silica particles, fumed silica particles, surface-modified silica particles, and the like. The surface-modified silica particles refer to the silica particles, in which a metal such as aluminum, titanium or zirconium, or an oxide thereof is adsorbed and/or bound to the surface of the silica particles directly or via a coupling agent, or those which are bound with a silane coupling agent, a titanium coupling agent, or the like.

Further, among them, the colloidal silica particles are preferable. The colloidal silica particles have a particle shape of nearly spherical, and can be stably dispersed for a long time period in the state of primary particles, so that aggregated particles are less likely to be formed, whereby scratches on a surface to be polished can be reduced.

The colloidal silica particles can be obtained by an alkali silicate method using an alkali metal silicate such as sodium silicate as a raw material, thereby allowing the silica particles to grow by condensation reaction in an aqueous solution; or an alkoxysilane method using tetraethoxysilane or the like as a raw material, thereby allowing silica particles to grow by condensation reaction in water containing a water-soluble organic solvent such as an alcohol. The fumed silica particles can be obtained by a method including the step of hydrolyzing a volatile silicon-containing compound such as silicon tetrachloride used as a raw material in a gas phase at a high temperature of 1000° C. or more with an oxyhydrogen burner. These silica particles may be used alone or in admixture of two or more kinds.

The average particle size of the colloidal silica particles is preferably from 5 to 500 nm, more preferably from 10 to 300 nm, even more preferably from 20 to 200 nm, from the viewpoint of polishing rate and from the viewpoint of preventing precipitation and separation of the colloidal silica particles. The average particle size of the colloidal silica particles is an average particle size of primary particles calculated by using a specific surface area as determined by BET method. Here, the particle size (nm) obtained according to the BET method is calculated by the equation:

Particle Size (nm)=2720/Specific Surface Area [m²/g].

The average particle size of the fumed silica particles is preferably from 20 to 2000 nm, more preferably from 30 to 1000 nm, even more preferably from 40 to 800 nm, even more preferably from 50 to 400 nm, from the viewpoint of polishing rate and from the viewpoint of preventing precipitation and separation of the fumed silica particles. Since the fumed silica particles are subjected to secondary aggregation, the average particle size of the fumed silica particles is an average particle size of secondary particles measured by light scattering method or light diffraction method.

The amount of the silica particles is preferably from 1 to 50% by weight, more preferably from 3 to 40% by weight, even more preferably from 5 to 30% by weight, of the polishing composition, from the viewpoint of polishing rate for the upper limit, and from the viewpoints of dispersion stability of the silica particles and costs for the lower limit.

In the present invention, the polymer particles include the particles made of a thermoplastic resin and particles made of a thermosetting resin, wherein the particles are not substantially dissolved in water and can exist as dispersed particles. The thermoplastic resin includes polystyrenic resins, (meth)acrylic resins, polyolefin resins, polyvinyl chloride resins, elastomeric resins, polyester resins, polyamide resins, polyacetal resins, and the like. The thermosetting resin includes phenolic resins, epoxy resins, urethane resins, urea resins, melamine resins, and the like. As the resin, the particles made of the thermoplastic resin are preferable, from the viewpoints of polishing rate and planarization property. Among them, the particles made of a polystyrenic resin or (meth)acrylic resin are more preferable.

The polystyrenic resin includes polystyrenes, styrenic copolymers, and the like. The styrenic copolymer is a copolymer made of styrene and various unsaturated ethylenic monomers. The copolymerizable unsaturated ethylenic monomer includes carboxylic acid monomers such as acrylic acid, methacrylic acid, itaconic acid, maleic acid and fumaric acid; (meth)acrylic ester monomers such as methyl (meth)acrylate, ethyl (meth)acrylate, butyl (meth)acrylate and 2-ethylhexyl (meth)acrylate; sulfonic acid monomers such as sodium styrenesulfonate and acrylamide t-butyl sulfonic acid; amino-based monomers such as dimethylaminoethyl methacrylate, dimethylaminopropyl methacrylamide and vinylpyridine; quaternary ammonium salt-based monomers such as methacrylamide propyltrimethylammonium chloride and methacryloyloxyethyltrimethylammonium chloride; nonionic monomers such as 2-hydroxyethyl methacrylate and methoxypolyethylene glycol methacrylate; cross-linkable monomers such as divinylbenzene, ethylene glycol dimethacrylate, ethylenebis acrylamide and trimethylolpropane trimethacrylate; and the like.

The (meth)acrylic resin includes polymethyl (meth)acrylates, polyethyl (meth)acrylates, polybutyl (meth)acrylates, poly-2-ethylhexyl (meth)acrylates, acrylic copolymers, and the like. The acrylic copolymer includes copolymers made of one or more (meth)acrylic monomers selected from methyl (meth)acrylate, ethyl (meth)acrylate, butyl (meth)acrylate and 2-ethylhexyl (meth)acrylate, and various unsaturated ethylenic monomers. As the copolymerizable unsaturated ethylenic monomer, the same monomers as those for the styrenic copolymers can be included.

Even more preferably, when the polymer particles are made of a polystyrenic resin or (meth)acrylic resin, the polymer particles can be cross-linked and used. The cross-linking can be carried out by properly copolymerizing the polymer particles with the above-mentioned copolymerizable cross-linkable monomers. The extent of the cross-linking can be expressed by a degree of cross-linking, and the degree of cross-linking is preferably from 0.5 to 50, more preferably from 1 to 30, from the viewpoint of polishing rate for the upper limit, and from the viewpoint of increasing evenness on a surface to be polished for the lower limit. Here, the degree of cross-linking refers to a percent by weight of an initially charged copolymerizable, cross-linkable monomer per polymer.

The resin constituting the polymer particles is those having a glass transition temperature of preferably 200° C. or lower, more preferably 180° C. or lower, even more preferably 150° C. or lower, from the viewpoint of an effect of increasing the polishing rate. The resin having a glass transition temperature of 200° C. or lower includes thermoplastic resins such as polyethylene (−120° C.), polypropylene (−10° C.), polystyrene (100° C.), polymethyl acrylate (3° C.), polymethyl methacrylate (115° C.: syndiotactic, 45° C.: isotactic), polybutyl methacrylate (21° C.), polyvinyl chloride (87° C.), polychloroprene (−50° C.) and polyvinyl acetate (28° C.). The values of the glass transition temperatures are those described in “Kobunshi to Fukugozairyo no Rikigakuteki Seishitsu (Mechanical Characteristics of Polymers and Composite Materials)” (1976) 316-318, published by K.K. Kagaku Dojin. The glass transition temperature can be determined by the method described in “Kobunnshi Sokutei-ho—Kozo to Bussei—Jokan (Determination Methods for Polymers—Structures and Properties—upper volume) (1973), 181, published by BAIFUKAN CO., LTD.

The polymer particles can be obtained by a process of directly obtaining the particles from an unsaturated ethylenic monomer by means of emulsion polymerization, precipitation polymerization or suspension polymerization, a process of subjecting the polymer to emulsion dispersion, or a process of powdering a bulky resin. Furthermore, the polymer particles obtained as described above can be classified as occasion demands and used. Among them, the emulsion polymerization is preferred from the viewpoint that the polymer particles having a useful particle size in the present invention can be easily obtained.

The average particle size of the polymer particles is preferably from 10 to 1000 nm, more preferably from 20 to 800 nm, even more preferably from 20 to 500 nm, from the viewpoints of increase in polishing rate and planarization property, and from the viewpoint of prevention of precipitation and separation of the polymer particles. The average particle size can be determined by light scattering method or light diffraction method.

In addition, it is preferable that the average particle size Dp (nm) of the polymer particles and the average particle size Di (nm) of the silica particles satisfy the formula: Dp≦Di+50 nm, from the viewpoint of increase in polishing rate. Here, Dp and Di are values for the average particle sizes of each of the polymer particles and the silica particles expressed by the unit of “nm.”

The amount of the polymer particles is preferably from 0.1 to 20% by weight, more preferably from 0.2 to 15% by weight, even more preferably from 0.3 to 10% by weight, of the polishing composition, from the viewpoints of increase in polishing rate and planarization property.

In the present invention, the cationic compound refers to a compound having a positive ionic group or an amino group in its molecule. Among these cationic compounds, at least one compound selected from the group consisting of amine compounds, quaternary ammonium salt compounds, betain compounds and amino acid compounds is preferable, from the viewpoint of planarization property. These compounds can be used as a mixture. Furthermore, the quaternary ammonium salt compounds are preferable, from the viewpoint of stability against change with the passage of time.

The molecular weight of the cationic compound is preferably from 30 to 10000, more preferably from 30 to 1000, even more preferably from 30 to 500, even more preferably from 40 to 200, from the viewpoint of water solubility. The number of amino groups and/or quaternary ammonium groups contained in one molecule of the cationic compound is preferably from 1 to 20, more preferably from 1 to 10, even more preferably from 1 to 5, from the viewpoint of water solubility. The ratio of carbon atoms to nitrogen atoms (C/N ratio) contained in one molecule of the cationic compound is preferably from 1 to 20, more preferably from 1 to 15, even more preferably from 1 to 10, from the viewpoint of water solubility.

The amine compound includes a monoamine, a polyamine, an amine having one or more OH groups, an amine having ether group, and a heterocyclic ring-containing compound containing nitrogen atom.

As the monoamine, those having 1 to 20 carbon atoms, more preferably from 1 to 10 carbon atoms, even more preferably from 1 to 6 carbon atoms, even more preferably from 1 to 4 carbon atoms are preferred, from the viewpoint of water solubility. Concrete examples of the monoamine include primary amines such as methylamine, ethylamine, n-propylamine, isopropylamine, n-butylamine, isobutylamine, sec-butylamine, tert-butylamine, valerylamine, isovalerylamine, cyclohexylamine, benzylamine and allylamine; secondary amines, such as dimethylamine, ethylmethylamine, diethylamine, methylpropylamine, isopropylmethylamine, ethylpropylamine, butylmethylamine, butylethylamine, di-n-propylamine and diallylamine; and tertiary amines such as trimethylamine, triethylamine, dimethylethylamine, diethylmethylamine and diisopropylethyl amine.

As the polyamine, those having 1 to 30 carbon atoms, more preferably from 2 to 20 carbon atoms, even more preferably from 2 to 15 carbon atoms, even more preferably from 2 to 10 carbon atoms are preferred, from the viewpoint of water solubility. Concrete examples of the polyamine include diamines such as ethylenediamine, 1,2-propanediamine, trimethylenediamine, tetramethylenediamine, pentamethylenediamine, hexamethylenediamine, bis(dimethylamino)methane, N,N-dimethylethylenediamine, N,N′-dimethylethylenediamine, N-ethylethylenediamine, N-methyl-1,3-propanediamine, 1,3-diaminopentane, N-isopropylethylenediamine, N-isopropyl-1,3-propanediamine, N,N,N′,N′-tetramethylethylenediamine, N,N,N′,N′-tetramethyltrimethylenediamine, N,N,N′,N′-tetramethyl-1,2-propanediamine, N,N,2,2-tetramethyl-1,3-propanediamine, N,N,N′,N′-tetramethyltetramethylenediamine, N,N-dimethyl-1,6-diaminohexane, N,N,N′,N′-tetramethyl-2,2-dimethyl-1,3-propanediamine and N,N,N′,N′-tetramethylhexamethylenediamine; and a polyamine having three or more amino groups in its molecule, such as diethylenetriamine, bis(3-aminopropyl)amine, N-(3-aminopropyl)-1,3-propanediamine, 3,3′-diamino-N-methyldipropylamine, spermidine, N,N,N′,N′,N″-pentamethyldiethylenetriamine, 3,3′-iminobis(N,N-dimethylpropylamine), bis(hexamethylene)triamine, triethylenetriamine, N,N′-bis(3-aminopropyl)ethylenediamine and tetraethylenepentamine.

In addition, as the amine having one or more OH groups and the amine having ether group, those having 1 to 30 carbon atoms, more preferably from 2 to 20 carbon atoms, even more preferably from 2 to 15 carbon atoms, even more preferably from 2 to 10 carbon atoms are preferred, from the viewpoint of water solubility. Concrete examples thereof include an amine containing one or more OH groups, such as monoethanolamine, 1-aminopropanol, 3-aminopropanol, 2-methylaminoethanol, 2-amino-1-butanol, 2-amino-2-methyl-1-propanol, N,N-diethylhydroxyamine, N,N-dimethylethanolamine, 2-ethylaminoethanol, 1-(dimethylamino)-2-propanol, 3-dimethylamino-1-propanol, 2-(isopraopylamino)ethanol, 2-(butylamino)ethanol, 2-(tert-butylamino)ethanol, N,N-diethylethanolamine, 2-dimethylamino-2-methyl-1-propanol, 2-(diisopropylamino)ethanol, 2-(dibutylamino)ethanol, 6-dimethylamino-1-hexanol, diethanolamine, 2-amino-2-methylpropanediol, N-methyldiethanolamine, diisopropanolamine, 2-{2-(dimethylamino)ethoxy}ethanol, N-ethyldiethanolamine, N-butyldiethanolamine, triisopropanolamine, triethanolamine and 2-(2-aminoethylamino)ethanol; and an amine containing ether group, such as 2-methoxyethylamine, 2-amino-1-methoxypropane, 3-methoxypropylamine, 3-ethoxypropylamine, 3-isopropoxypropylamine, bis(2-methoxyethyl)amine, 2,2′-(ethylenedioxy)bis(ethylamine) and 4,7,10-trioxa-1,13-tridecanediamine.

The other amines include polymeric amines such as polyethyleneimines, polyvinylamines and polyallylamines.

In addition, there are included a heterocyclic ring-containing compound containing nitrogen atom such as piperidine, piperazine, pyridine, pyrazine, pyrrole, triethylenediamine, morpholine, 2-aminopyridine, 3-amino-1,2,4-triazole; and the like.

The quaternary ammonium salt compound has preferably 4 to 20 carbon atoms, more preferably from 4 to 15 carbon atoms, even more preferably from 4 to 7 carbon atoms, from the viewpoint of water solubility. However, the number of carbon atoms does not include carbon atoms contained in a counter anion. The quaternary ammonium salt compound is preferably a compound represented by the following formulas (I) and (II):

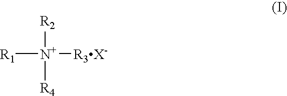

wherein each of R₁, R₂, R₃ and R₄ is independently an aliphatic alkyl group having 1 to 8 carbon atoms, phenyl group, benzyl group or an alkanol group having 1 to 3 carbon atoms; and X⁻ is a monovalent cation; and

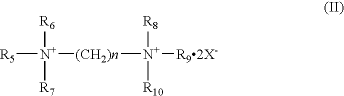

wherein each of R₅, R₆, R₇, R₈, R₉, and R₁₀ is independently an aliphatic alkyl group having 1 to 8 carbon atoms, phenyl group, benzyl group or an alkanol group having 1 to 3 carbon atoms; X⁻ is a monovalent cation; and n is an integer of from 1 to 12.

In the formula (I), each of R₁, R₂, R₃ and R₄ is independently an aliphatic alkyl group having 1 to 8 carbon atoms, phenyl group, benzyl group or an alkanol group having 1 to 3 carbon atoms. The aliphatic alkyl group has preferably 1 to 6 carbon atoms, more preferably from 1 to 4 carbon atoms, even more preferably from 1 to 2 carbon atoms, from the viewpoint of water solubility. X⁻ is a monovalent cation, and X⁻ includes OH⁻, F⁻, Cl⁻, Br⁻, I⁻, NO₃⁻, HSO₄⁻, CH₃SO₃⁻, H₂PO₄⁻, HCOO⁻, CH₃COO⁻, CH₃CH(OH)COO⁻, C₂H₅COO⁻, and the like. When used for polishing a semiconductor substrate, OH⁻, CH₃COO⁻ and HCOO⁻ are preferable. Concrete examples of the quaternary ammonium salt compound represented by the formula (I) include tetramethylammonium salts, tetraethylammonium salts, tetrapropylammonium salts, tetrabutylammonium salts, ethyltrimethylammonium salts, propyltrimethylammonium salts, butyltrimethylammonium salts, N-hydroxyethyl-N,N,N-trimethylammonium salts, N-hydroxypropyl-N,N,N-trimethylammonium salts, N-hydroxyethyl-N-hydroxypropyl-N,N-dimethylammonium salts, phenyltrimethylammonium salts, benzyltrimethylammonium salts, benzyltriethylammonium salts, and the like. In addition, examples of these salts include salts with hydroxides, chlorides, bromides, acetates and formates.

In the formula (II), each of R₅, R₆, R₇, R₈, R₉ and R₁₀ is independently an aliphatic alkyl group having 1 to 8 carbon atoms, phenyl group, benzyl group or an alkanol group having 1 to 3 carbon atom. The aliphatic alkyl group has preferably 1 to 6 carbon atoms, more preferably from 1 to 4 carbon atoms, even more preferably from 1 to 2 carbon atoms, from the viewpoint of water solubility. Also, X⁻ is a monovalent cation, and X⁻ includes OH⁻, F⁻, Cl⁻, Br⁻, I⁻, NO₃⁻, HSO₄⁻, CH₂SO₃⁻, H₂PO₄⁻, HCOO⁻, CH₃COO⁻, CH₃CH(OH)COO⁻, C₂H₅COO⁻, and the like. When used for polishing a semiconductor substrate, OH⁻, CH₃COO⁻, HCOO⁻ are preferable. n is an integer of from 1 to 12, and preferably from 1 to 8, more preferably from 1 to 6, from the viewpoint of water solubility. Concrete examples of the quaternary ammonium salt compound represented by the formula (II) include N,N′-tetramethylenebis(trimethylammonium salts), N,N′-pentamethylenebis(trimethylammonium salts), N,N′-hexamethylenebis(trimethylammonium salts), and the like. In addition, examples of these salts include salts with hydroxides, chlorides, bromides, acetates and formates.

The betain compound has preferably from 5 to 20 carbon atoms, more preferably from 5 to 15 carbon atoms, even more preferably from 5 to 10 carbon atoms, even more preferably from 5 to 8 carbon atoms, from the viewpoint of water solubility. Concrete examples of the betain compound include carboxybetains such as trimethylglycine and trimethylaminopropionate betain; imidazolium betains such as 2-methyl-N-carboxymethyl-N-hydroxyethylimidazolinium betain; sulfobetains such as 2-hydroxy-3-sulfopropyltrimethyl betain; and the like.

The amino acid compound has preferably from 1 to 20 carbon atoms, more preferably from 1 to 15 carbon atoms, even more preferably from 1 to 10 carbon atoms, even more preferably from 1 to 6 carbon atoms, from the viewpoint of water solubility. Concrete examples of the amino acid compound include α-amino acids such as glycine, alanine, serine, tryptophan, glutamine, lysine and alginine; β-amino acids such as β-alanine; γ-amino acids such as γ-aminobutyrate; and the like.

Among them, propylamine, isopropylamine, butylamine, hexamethylenediamine, N,N,N′,N′-tetramethylhexamethylenediamine, diethylenetriamine, bis(3-aminopropyl)amine, tetramethylammonium salts, N-hydroxypropyl-N,N,N-trimethylammonium salts, N-hydroxyethyl-N-hydroxypropyl-N,N-dimethylammonium salts, N,N′-hexamethylenebis(trimethylammonium salts), alginine and the like are more preferable, from the viewpoint of water solubility and from the viewpoint of planarization property.

The amount of the cationic compound is preferably 0.01% by weight or more, more preferably 0.05% by weight or more, even more preferably 0.1% by weight or more, of the polishing composition, from the viewpoint of planarization property. In addition, the amount is preferably 20% by weight or less, more preferably 15% by weight or less, even more preferably 10% by weight or less, of the polishing composition, from the viewpoint of polishing rate. From the both viewpoints, the amount is preferably from 0.01 to 20% by weight, more preferably from 0.05 to 15% by weight, even more preferably from 0.1 to 10% by weight.

In the present invention, as the aqueous medium, there can be used water and mixed solvents of water and a water-miscible solvent such as an alcohol. It is preferable to use water such as ion-exchanged water. The content of the aqueous medium is preferably from 40 to 98.85% by weight, more preferably from 60 to 95% by weight, of the polishing composition, from the viewpoint of increase in polishing rate and from the viewpoint of prevention of precipitation and separation of the silica particles and the polymer particles.

The polishing composition of the present invention can be prepared by formulating the silica particles, the polymer particles and the cationic compound to an aqueous medium. Among them, the process including the step of mixing an aqueous dispersion containing the silica particles, an aqueous dispersion containing the polymer particles, and an aqueous solution of the cationic compound with stirring is preferable, from the viewpoint of dispersion stability of the silica particles and the polymer particles upon formulation.

The aqueous dispersion containing the silica particles can be prepared by, for instance, the following processes:

a process including the steps of further pulverizing powdery silica particles as occasion demands and formulating pulverized silica particles to an aqueous medium, and more forcibly dispersing with a mechanical power such as ultrasonication, agitation or kneading; and

a process including the step of allowing silica particles to grow in an aqueous medium.

Among them, the process including the step of allowing silica particles to grow in an aqueous medium is preferable, because the resulting silica particles are stably dispersed in the form of primary particles and the control of the particle sizes is facilitated.

The aqueous dispersion containing the polymer particles can be prepared by, for instance, the following processes:

a process including the step of polymerizing a monomer using an aqueous medium, or copolymerizing the monomer with other monomer as occasion demands, thereby directly giving polymer particles formed and an aqueous medium containing the polymer particles;

a process including the step of polymerizing a monomer using an organic solvent, or copolymerizing the monomer with other monomer as occasion demands, subjecting the polymer particles formed and the organic solvent containing the polymer particles to solvent substitution with an aqueous medium by means of distillation or the like, to give an aqueous dispersion; and

a process including the step of polymerizing a monomer using an aqueous medium or an organic solvent, drying, pulverizing or the like the resulting polymer, and thereafter re-dispersing the resulting powder in an aqueous medium to give an aqueous dispersion.

Among them, the process including the step of polymerizing a monomer using an aqueous medium, or copolymerizing a monomer with other monomer as occasion demands, thereby directly giving polymer particles formed and an aqueous medium containing the polymer particles is preferably employed as an aqueous dispersion, because the process is convenient, and the control of the average particle size of the resulting polymer particles is facilitated.

The pH of the polishing composition of the present invention is preferably from 7 to 13, more preferably from 8 to 12, even more preferably from 9 to 12, from the viewpoint of polishing rate and from the viewpoint of negatively charging the silica particles and a substrate to be polished to accelerate the formation of an adsorbent coating film made of the cationic compound to the surfaces of the silica particles and the substrate.

For the purpose of adjusting the polishing composition to the pH defined above, a pH adjusting agent can be used. The pH adjusting agent includes basic substances such as an aqueous ammonia, potassium hydroxide, sodium hydroxide, water-soluble organic amines and quaternary ammonium hydroxide; and acidic substances including organic acids such as acetic acid, oxalic acid, succinic acid, glycolic acid, malic acid, citric acid and benzoic acid, and inorganic acids such as nitric acid, hydrochloric acid, sulfuric acid and phosphoric acid.

The polishing composition of the present invention can be formulated with various additives as occasion demands. The additive includes a dispersion stabilizer, a preservative, and the like.

The dispersion stabilizer includes surfactants such as anionic surfactants, cationic surfactants and nonionic surfactants; polymeric dispersants such as polyacrylic acids or salts thereof, acrylic acid copolymers and ethylene oxide/propylene oxide block copolymers (Pluronics); and the like.

The preservative includes benzalkonium chloride, benzethonium chloride, 1,2-benzisothiazolin-3-one, hydrogen peroxide, hypochlorites and the like.

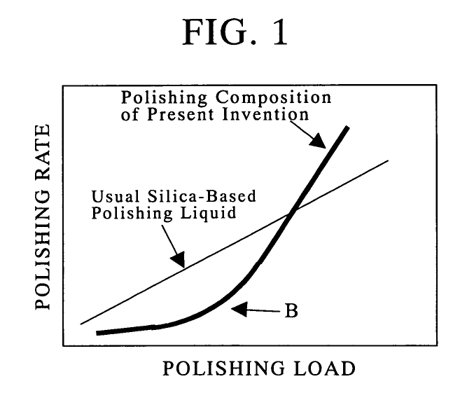

In the polishing composition of the present invention, when polishing an object to be polished having no dent and projection patterns on the surface to be polished, the polishing rate is kept low in a region in which the polishing load is small, and a high polishing rate is exhibited in a region in which the polishing load is large. Therefore, there is exhibited a polishing property that the polishing rate is greatly dependent upon the polishing load, thereby showing a point where the polishing rate dramatically changes, when the polishing rate is plotted against the polishing load (bending point). On the other hand, in a case of usual silica-based polishing composition, there is exhibited a polishing property that the polishing rate is almost proportional to the polishing load and does not have a bending point (see FIG. 1).

The reasons why the polishing composition of the present invention shows the polishing property as described is not clear. Although not wanting to be limited by theory, it is presumably due to the coexistence of the silica particles, the polymer particles and the cationic particles for the reasons set forth below. First, in a low load region, i.e., under a weak shearing force, the polymer particles maintain a stable dispersion state, so that an interaction between the polymer particles and the abrasive grains hardly takes place. On the other hand, the cationic compound contained in the polishing composition of the present invention forms an adsorbent coating film on the surfaces of the silica particles and the object to be polished which are negatively charged, thereby inhibiting the polishing action to the surface to be polished by the silica particles. Therefore, the polishing rate is lowered mainly due to the action of the adsorbent coating film of the cationic compound.

By contrast, in a high load region, since a strong shearing force is applied to the polymer particles, the polymer particles aggregate together with the silica particles, thereby forming aggregate composite particles having a strong polishing power. On the other hand, the cationic compound forms an adsorbent coating film regardless of the intensity of the shearing force. However, since a strong polishing power is acted by the aggregated composite particles, the adsorbent coating film is broken, so that the polishing rate increases. Therefore, although not wanting to be limited by theory, it is presumed that the polishing composition consequently exhibits a polishing property in which the polishing rate largely depends on the polishing load.

Even more preferably, in a case where the surface to be polished having the dents and projections is polished with the polishing composition of the present invention, a polishing load P1 is set at the neighborhood of at a point where the slope (magnitude of the polishing rate to the polishing load) most dramatically changes in the polishing property curve of the polishing composition of the present invention as shown, for instance, in FIG. 1. By the above setting, the projection portions are locally polished with a higher polishing rate corresponding to a polishing load equal to or greater than P1, and conversely, the dent portions are locally polished with a lower polishing rate corresponding to a polishing load equal to or less than P1, as compared to those of the silica-based polishing composition containing silica particles alone. Therefore, only the projection portions are selectively polished efficiently, thereby efficiently progressing the reduction of step height. With the reduction of step height by a further progress of polishing, since local polishing loads applied to the projection portions and the dent portions both approximate the polishing load P1, the polishing rate is reduced at both of the projection portions and the dent portions. Therefore, there is exhibited a characteristic polishing property that the polishing hardly progresses after the disappearance of the step height. In the usual silica-based polishing composition, when polishing a substrate having on the surface to be polished having mixed patterns with different densities or sizes in the dents and projections, since the polishing progresses at the dent portions as well as the projection portions and the polishing further progresses even after the disappearance of the step height, the disadvantageous effect of so-called “pattern dependence” is likely to be generated. In the polishing composition of the present invention, the polishing after the disappearance of the step height is hardly progressed, thereby consequently exhibiting an excellent effect that the high planarization having less pattern independence can be quickly achieved with a small amount to be polished.

Accordingly, since the polishing composition of the present invention is used for polishing a substrate for a precision part, there can be achieved a high level of planarization in a substrate having the desired thickness, even more preferably in a substrate having the dents and projections on the surface, on which a thin film is formed. In other words, the present invention relates to a polishing process for a substrate for a precision part with the above-mentioned polishing composition, a method for planarization of a substrate for a precision part with the above-mentioned polishing composition, and a method for manufacturing a substrate for a precision part with the above-mentioned polishing composition.

The material for objects to be polished represented by a substrate for a precision part that is the subject of the present invention includes, for instance, metals or metalloids such as silicon, aluminum, nickel, tungsten, copper, tantalum and titanium; alloys made of these metals as main components; glassy substances such as glass, glassy carbon and amorphous carbons; ceramic materials such as alumina, silicon dioxide, silicon nitride, tantalum nitride, titanium nitride and polysilicon; resins such as polyimide resins; and the like. Even more preferably, in a case where a substrate for a precision part having a film containing silica formed on a surface to be polished such as glass, a thermal oxidative film, TEOS film, silicon nitride film, BPSG film, or polysilicon film, preferably a substrate having silicon dioxide such as glass or TEOS film (for instance, a semiconductor substrate) is polished with the polishing composition of the present invention, the planarization of a substrate can be efficiently realized.

2. Polishing Process for Substrate for Precision Part:

The polishing process for a substrate for a precision part with the polishing composition of the present invention is not particularly limited, and general processes can be employed. Among them, a process using a polishing machine containing a jig for supporting an object to be polished represented by a substrate for a precision part and a polishing pad is even more preferably employed. The polishing pad includes those made of an organic polymer-based foamed article, a non-foamed article, these foamed articles filled with polymer particles, or a nonwoven polishing pad. The polishing process includes the step of polishing a surface of an object to be polished by pressing the above-mentioned jig for supporting the object to be polished against polishing platens to which a polishing pad is attached, or alternatively by setting the above-mentioned object to be polished with polishing platens to which the polishing pad is attached, feeding the polishing composition of the present invention to a surface of the object to be polished, and moving the polishing platens or the object to be polished, with applying a given pressure.

It is preferable that the process of feeding the polishing composition is a process including the step of feeding the polishing composition to a polishing pad in a state that the constituents of the polishing composition are sufficiently mixed. Concretely, the process of feeding the polishing composition may be carried out by feeding constituents of the polishing composition which are previously mixed in a given concentration to a polishing pad with a pump or the like; or a process including the steps of separately preparing an aqueous dispersion or aqueous solution of each of the constituents, or a premixed solution prepared by mixing a part of those, feeding each of the constituents in the form of aqueous dispersions, aqueous solutions or the premixed solution with a pump or the like, and mixing the aqueous dispersion or the like in a feed pipe, thereby feeding the polishing composition in a given concentration to a polishing pad. In the case of mixing the constituents in the forms of aqueous dispersions, aqueous solutions or the premixed solution in a feed pipe, it is preferable to provide a mixer for accelerating the agitation of the mixture in the feed pipe so as to sufficiently mix the constituents in the form of aqueous dispersions, aqueous solutions or the premixed solution.

3. Method for Manufacturing Substrate for Precision Part and Method for Planarization of Substrate for Precision Part

In the method for manufacturing a substrate for a precision part of the present invention, firstly as a first step, the polishing of a surface to be polished of the substrate is carried out with the polishing composition of the present invention containing silica particles, polymer particles and a cationic compound in an aqueous medium, the polishing composition being hereinafter referred to as “the first polishing composition,” at a polishing load of from 50 to 1000 hPa (P1).

Next, successively after the end of the first step or after carrying out other steps after the first step as occasion demands, as a second step, polishing of the surface to be polished of the substrate is carried out with a second polishing composition containing the silica particles in an aqueous medium at a polishing load of from 50 to 1000 hPa (P2). By carrying out the second step, there is exhibited an effect that the polishing rate that is lowered by the time at the end of the first step can be increased again, and polishing can be carried out to the desired polishing position in depth. Also, since the planarization having small pattern dependency is basically achieved in the first step, there is exhibited an effect that polishing can be easily carried out uniformly over an entire surface to be polished of the substrate to the desired polishing position.

Therefore, in the present invention, by carrying out the polishing treatments in combination of both of the first step and the second step, polishing over the entire surface to be polished of the substrate can be uniformly carried out to the desired position in depth, for instance, up to a stopper film and the like in CMP technique including, for instance, shallow trench isolation, planarization of interlayer dielectric, formation of embedded metal line, plug formation, formation of embedded capacitor, and the like. Therefore, there is exhibited an excellent effect that a substrate subjected to a high level of planarization, even more preferably a substrate for a precision part having a surface on which a thin film is formed and having a desired thickness can be efficiently obtained.

Each of the polishing load P1 in the first step and the polishing load P2 in the second step is from 50 to 1000 hPa, preferably from 70 to 600 hPa, even more preferably from 100 to 500 hPa, from the viewpoint of reducing scratches for the upper limit, and from the viewpoint of polishing rate for the lower limit.

The other steps except for the above-mentioned steps include rinsing step, dressing step, buff polishing step or cleaning step, and the like.

The first polishing composition used in the present invention is the polishing composition of the present invention, and its composition may be the same as that mentioned above.

The kind and the content of the silica particles of the second polishing composition may be the same as those of the above-mentioned first polishing composition.

The aqueous medium which can be used in the second polishing composition may be the same as that of the above-mentioned first polishing composition. The content of the aqueous medium is preferably from 50 to 99% by weight, more preferably from 60 to 97% by weight, of the second polishing composition, from the viewpoint of preventing precipitation and separation of the silica particles for the lower limit, and from the viewpoint of increasing polishing rate for the upper limit.

The second polishing composition can be prepared by formulating the silica particles into an aqueous medium. There can be employed a process including the steps of further pulverizing the powdery silica particles as occasion demands, adding the silica particles to an aqueous medium, and further forcibly dispersing with a mechanical power such as ultrasonication, agitation or kneading; and a process including the step of allowing silica particles to grow in an aqueous medium.

In the second polishing composition, polymer particles and/or a cationic compound can be formulated as occasion demands. In this case, the content of the polymer particles is preferably 1% by weight or less, more preferably 0.5% by weight or less, even more preferably less than 0.1% by weight, even more preferably 0.05% by weight or less, of the second polishing composition, from the viewpoint of preventing the excessive increase of polishing rate and easily controlling the timing of the end of polishing. In addition, the content of the cationic compound is preferably 0.1% by weight or less, more preferably 0.05% by weight or less, even more preferably 0.01% by weight or less, even more preferably 0.005% by weight or less, of the second polishing composition, from the viewpoint of ensuring polishing rate that is necessary for polishing the substrate to the desired polishing position in depth. Furthermore, it is preferable that the content of the cationic compound has a relationship such that the content of the cationic compound of the first polishing composition is greater than that of the second polishing composition, from the viewpoint of efficiently obtaining the substrate having high level of planarization. A process for preparing the second polishing composition may be, the same as that of the above-mentioned first polishing composition even more preferably when the above-mentioned two components, i.e. the polymer particles and the cationic compound, are used together.

The pH of the second composition is the same as that of the first polishing composition mentioned above, from the viewpoint of increasing polishing rate based on an etching action with an alkali. In order to adjust the second polishing composition to the pH as defined above, a pH adjusting agent can be used. The pH adjusting agent may be the same as that of the above-mentioned first polishing composition.

In the second polishing composition, various additives can be added as occasion demands. These additives may be the same as those of the above-mentioned first polishing composition.

The feed amount of the first polishing composition in the first step and the kinds and the feed amount of the second polishing composition in the second step may be appropriately determined depending upon the kinds and a desired thickness of a substrate for a precision part and the like.

The method for manufacturing a substrate for a precision part of the present invention can be used in the step of polishing a surface to be polished of a semiconductor substrate, that is a kind of a substrate for a precision part, to achieve planarization. For instance, the process includes the steps of polishing silicon ware (bare ware), forming a film for shallow trench isolation, subjecting interlayer dielectric to planarization, forming embedded metal line, forming embedded capacitor, and the like. The present invention is even more preferably suitable for the steps of forming a film for shallow trench isolation, subjecting interlayer dielectric to planarization, and forming embedded capacitor, so that the present invention is suitably used for manufacturing a semiconductor device such as memory ICs, logic ICs or system LSIs. Accordingly, the present invention relates to a semiconductor device utilizing a substrate for a precision part obtained by the method for manufacturing a substrate for a precision part.

The shape for these objects to be polished is not particularly limited. For instance, those having shapes containing planar portions such as disks, plates, slabs and prisms, or shapes containing curved portions such as lenses can be subjects for polishing with the polishing composition of the present invention. Among them, those having the disk-shaped objects to be polished are preferable in polishing, more preferably suitable for polishing for achieving planarization of a substrate for a precision part having dents and projections on which a thin film is formed, even more preferably suitable for polishing for achieving planarization of a semiconductor substrate to the desired thickness. Even more preferably, it suitable for polishing a semiconductor substrate having a step height of from 10 to 2000 nm, preferably from 50 to 2000 nm, more preferably from 100 to 1500 nm, for achieving planarization. Here, the step height of the dents and projections can be determined using a profile analyzer (for instance, HRP-100 (trade name) commercially available from KLA-Tencor). Accordingly, the present invention can be suitably used for the method for planarization of a substrate to be polished such as a substrate for a precision part.

The method for planarization of a substrate for a precision part of the present invention includes the step of polishing a substrate for a precision part with the polishing composition of the present invention. The method for planarization includes, for instance, comprises a method including the first step and the second step in the same manner as the above-mentioned method for manufacturing the substrate.

In the present invention, by carrying out the polishing treatments in combination of both of the first step and the second step, polishing over an entire surface to be polished of the substrate can be uniformly carried out to the desired position in depth up to a stopper film or the like in CMP technique including, for instance, shallow trench isolation, planarization of interlayer dielectric, formation of embedded metal line, plug formation, formation of embedded capacitor, and the like. Therefore, there is exhibited an excellent effect that a surface of a substrate can be subjected to planarization.

In the method for manufacturing a substrate for a precision part and the method for planarization of the substrate of the present invention, the first step and the second step may be successively carried out on the same polishing pad, or the second step may be carried out after rinsing step, dressing step, buff polishing step, cleaning step, or the like which is carried out subsequent to the first step. Furthermore, the rinsing step, the buff polishing step, the cleaning step or the like is carried out as occasion demands subsequent to the first step, and thereafter the second step may be carried out by moving the substrate to a different polishing pad.

The process for feeding the polishing composition is preferably a process including the step of feeding the polishing composition to a polishing pad in the state that the constituents of the polishing composition are sufficiently mixed. Concretely, a mixture prepared by previously mixing the constituents of the polishing composition so as to have a given concentration may be fed to a polishing pad with a pump or the like. Alternatively, the process of feeding may be carried out by preparing each of aqueous dispersions or aqueous solutions of the constituents, or a premixed solution of a part of those, feeding the constituents in the forms of aqueous dispersion, aqueous solution, a premixed solution or the like with a pump or the like, and mixing the constituents in a feed pipe, so that the polishing composition in a given concentration may be fed to a polishing pad. In the case of mixing the constituents in a feed pipe, it is preferable to provide a mixer for accelerating agitation of the components in the feed pipe so as to sufficiently mix the constituents in the forms of aqueous dispersions, aqueous solutions, the premixed solution or the like.

### EXAMPLES

The following examples further describe and demonstrate embodiments of the present invention. The examples are given solely for the purposes of illustration and are not to be construed as limitations of the present invention.

The expression “% by weight” in Examples is based on an entire amount of an aqueous dispersion of the polymer particles or an entire amount of a polishing composition. The expression “parts” means parts by weight.

Preparation Examples 1 to 3 are preparation examples for polymer particles made of polystyrene (glass transition point: 100° C.).

### Preparation Example 1 [Preparation of Polymer Particles (a)]

A 2-L separable flask was charged with 27 parts of styrene, 3 parts of 55% by weight divinylbenzene, 1.5 parts of a potassium salt of a fatty acid (commercially available from Kao Corporation under the trade name of KS SOAP), and 68.5 parts of ion-exchanged water, and the air inside the flask was substituted with nitrogen gas, and the temperature was raised to 65° C. The amount 0.06 parts of potassium persulfate was added to the flask, and the polymerization was carried out for 3 hours, to give an aqueous dispersion of the polymer particles. The polymer particles had an average particle size of 71 nm, as determined by light scattering method using electrophoretic light scattering (ELS) spectrophotometer (commercially available from Otsuka Electronics Co., Ltd. under the trade name of Laser Zeta Potentiometer) ELS8000.

### Preparation Example 2 [Preparation of Polymer Particles (b)]

A 2-L separable flask was charged with 30 parts of styrene, 1.5 parts of a potassium salt of a fatty acid (commercially available from Kao Corporation under the trade name of KS SOAP), and 68.5 parts of ion-exchanged water, and the air inside the flask was substituted with nitrogen gas, and the temperature was raised to 65° C. The amount 0.06 parts of potassium persulfate was added to the flask, and the polymerization was carried out for 3 hours, to give an aqueous dispersion of the polymer particles. The polymer particles had an average particle size of 80 nm, as determined by the same light scattering method as in Preparation Example 1.

### Preparation Example 3 [Preparation of Polymer Particles (c)]

A 2-L separable flask was charged with 27 parts of styrene, 3 parts of 55% by weight divinylbenzene, 1.5 parts of sulfosuccinate-type surfactant (commercially available from Kao Corporation under the trade name of LATEMUL S-180), and 68.5 parts of ion-exchanged water, and the air inside the flask was substituted with nitrogen gas, and the temperature was raised to 65° C. The amount 0.06 parts of potassium persulfate was added to the flask, and the polymerization was carried out for 3 hours, to give an aqueous dispersion of the polymer particles. The polymer particles had an average particle size of 81 nm, as determined by the same light scattering method as in Preparation Example 1.

### Example 1

Fifty-one parts of ion-exchanged water was added to 2.3 parts of N-hydroxypropyl-N,N,N-trimethylammonium formate (commercially available from Kao Corporation under the trade name of Kaolizer No. 430) to dissolve with stirring. Thereto were added 6.7 parts of an aqueous dispersion of the polymer particles (a) obtained in Preparation Example 1, out of which 2 parts were polymer particles, and 40 parts of an aqueous dispersion of colloidal silica (commercially available from Du Pont Kabushiki Kaisha under the trade name of Syton OX-K50, solid ingredient: 50%, average particle size: 40 nm) with stirring, to give a polishing composition. The pH of the polishing composition was adjusted with an aqueous potassium hydroxide to 10.5 to 11.5 as occasion demands.

The polishing test was carried out using the polishing composition as prepared above under the following conditions, and evaluated.

<Polishing Conditions>

Polishing testing machine: LP-541 (trade name, platen diameter: 540 mm), commercially available from Lap Master SFT

Polishing pad: IC-1000/Suba 400 (commercially available from RODEL NITIA).

Platen rotational speed: 60 r/min

Carrier rotational speed: 58 r/min

Flow rate of polishing liquid: 200 (g/min)

Polishing load: 200 to 500 (g/cm²) [1 g/cm²=0.98 hPa]

<Determination/Evaluation Method for Polishing Rate>

1. Blanket Wafer

Using each of the polishing compositions, an 8-inch (200-mm) silicon substrate having a 2 μm-PE-TEOS film formed thereon, which was used as an object to be polished (blanket wafer) was polished under the set conditions mentioned above for 2 minutes. The polishing rate (nm/min) was determined from the difference between the thickness of the remaining film before polishing and that of the remaining film after polishing. The thickness of the remaining film was determined using a light interference-type film thickness gauge (LAMBDA ACE VM-1000, commercially available from DAINIPPON SCREEN MFG. CO., LTD.). The polishing properties were evaluated by plotting the polishing rate against the polishing load.

2. Patterned Wafer

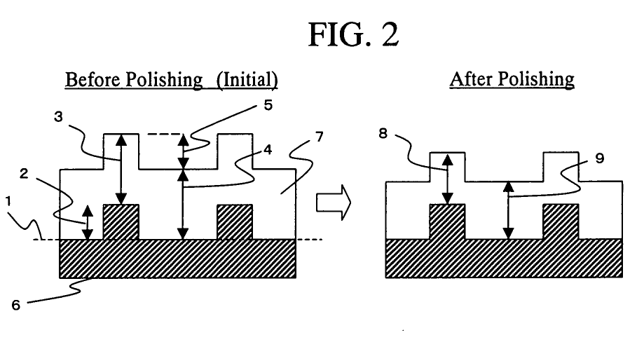

In order to evaluate the planarization property, the evaluation was made on the basis of time needed for removing the step height previously formed on the wafer by polishing with a commercially available wafer for evaluating CMP properties (patterned wafer, trade name; SKW 7-2, commercially available from SKW Associates, Inc., difference in step height: 800 nm) as an object to be polished. Specifically, first, an initial surface step height 5 (the determination method being described above), an initial thickness 3 at projection portion and an initial thickness 4 at dent portion (the determination methods being described above) which are shown in FIG. 2 of the GRADUAL D10, D50 and D90 patterns on the wafer before polishing (D10: line and space patterns of width of projection portion: 10 μm and width of dent portion: 90 μm; D50: line and space patterns of width of projection portion: 50 μm and width of dent portion: 50 μm; D90: line and space patterns of width of projection portion: 90 μm and width of dent portion: 10 μm) were determined, and a step height 2 of the substrate was calculated (step height 2 of the substrate=initial surface step height 5+initial thickness 4 at dent portion−initial thickness 3 at projection portion). Subsequently, the thicknesses of the remaining film of the projection portion and the dent portion of the GRADUAL D10, D50 and D90 patterns (D10: line and space patterns of width of projection portion: 10 μm and width of dent portion: 90 μm; D50: line and space patterns of width of projection portion: 50 μm and width of dent portion: 50 μm; D90: line and space patterns of width of projection portion: 90 μm and width of dent portion: 10 μm) on the wafer were determined every minute of polishing under the above-mentioned set conditions (the determination method was the same as above). From these determinations, the values corresponding to a height from the standard surface 1 of the projection portion and the dent portion (the remaining film thickness 8 of projection portion+the step height 2 of the substrate) and the remaining film thickness 9 of the dent portion as shown in FIG. 2 were plotted against the polishing time, and the planarization property and the pattern dependency were evaluated.

<Polishing Results for Blanket Wafer>

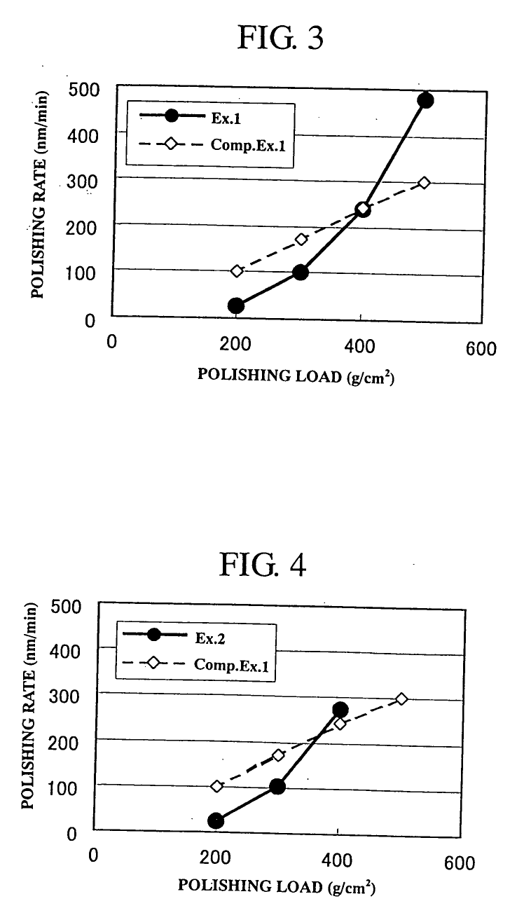

In the polishing of the blanket wafer carried out with the polishing composition of Example 1, the relationship between the polishing load and the polishing rate is shown in FIG. 3. In FIG. 3, for the sake of comparison, the results obtained by carrying out polishing with a polishing composition of Comparative Example 1 in which the polymer particles and the cationic compound are not formulated are also shown together. It is seen from FIG. 3 that the polishing rate is controlled with a low load (200 g/cm²), and exhibits a high polishing rate with a high load (500 g/cm²), thereby showing a critical point in the relationship of polishing load-polishing rate.

<Polishing Results of Patterned Wafer>

In the polishing of the patterned wafer carried out at a set polishing load of 300 g/cm² with the polishing composition of Example 1, a height from a standard surface of the dent portion and the projection portion for each polishing time, i.e. change with the passage of time of the progress of the polishing, is shown in FIG. 12. As compared to the results of polishing with the polishing composition of Comparative Example 1 (FIG. 20) in which the polymer particles and the cationic compound are not formulated, it can be seen that 1) the height of the projection portion (thickness) is more quickly reduced at an early stage of polishing of a polishing time of 1 to 2 minutes, and that 2) the polishing of the projection portion is progressed, and the progress of the polishing in both the projection portion and the dent portion is lowered at a point where there is little difference in height of the projection portion with that of the dent portion (step height), thereby controlling the difference in height between the patterns (D10, D50, D90) to a low value. As described above, the polishing composition of Example 1 has a high initial polishing rate at the projection portion, so that the planarization efficiency is high. Further, after the progress of the planarization, the progress of the polishing at both of the projection portion and the dent portion is lowered, thereby making it less likely to be dependent upon the dent and projection patterns. Therefore, it can be seen that a high level of planarization can be achieved.

### Examples 2 to 8 and Comparative Examples 1 to 3

Each polishing composition was prepared by mixing the silica particles shown in Table 1, the cationic compound shown in Table 2, and the polymer particles in the same manner as in Example 1 in accordance with the contents shown in Table 3. The blanket wafer and the patterned wafer were polished with the resulting polishing composition in the same manner as in Example 1, and evaluated.

TABLE 1

| | | | | Solid |
|---|---|---|---|---|
| | Kind | Trade Name | Manufacturer | Ingredient |
| (1) | Colloidal | Syton OX-K50 | Du Pont Kabushiki | 50% |
| | Silica | (Average Particle | Kaisha | |
| | | Size: 40 nm) | | |
| (2) | Fumed | SEMI-SPERSE 25 | Cabot | 25% |
| | Silica | (Average Particle | Microelectronics | |
| | | Size: 140 nm) | Corporation | |

TABLE 2

| | | | | Solid |
|---|---|---|---|---|
| | Name of Compound | Trade Name | Manufacturer | Ingredient |
| i | N-Hydroxypropyl- | Kaolizer No. 430 | Kao Corporation | 50% |
| | N,N,N-trimethylammonium formate | | | |
| ii | N-Hydroxyethyl-N-hydroxypropyl- | Kaolizer No. 410 | Kao Corporation | 100% |
| | N,N-dimethylammonium acetate | | | |
| iii | Tetramethylammonium chloride | Reagent | Wako Pure Chemical | 100% |
| | | | Industries, Ltd. | |
| iv | Tetramethylammonium hydroxide | TMAH | SACHEM Showa Co., Ltd. | 20% |
| v | Bis(3-aminopropyl)amine | Reagent | Wako Pure Chemical | 100% |
| | | | Industries, Ltd. | |
| vi | Arginine | Reagent | Wako Pure Chemical | 100% |
| | | | Industries, Ltd. | |

TABLE 3

| Silica Particles | | Polymer Particles | | Cationic Compound | | | |
|---|---|---|---|---|---|---|---|
| | Content | | Content | | Content | | |
| | (Solid | | (Solid | | (Solid | Evaluation Results | Set Polishing Load |
| Kind | Ingredient) | Kind | Ingredient) | Kind | Ingredient) | for Blanket Wafer | for Patterned Wafer |

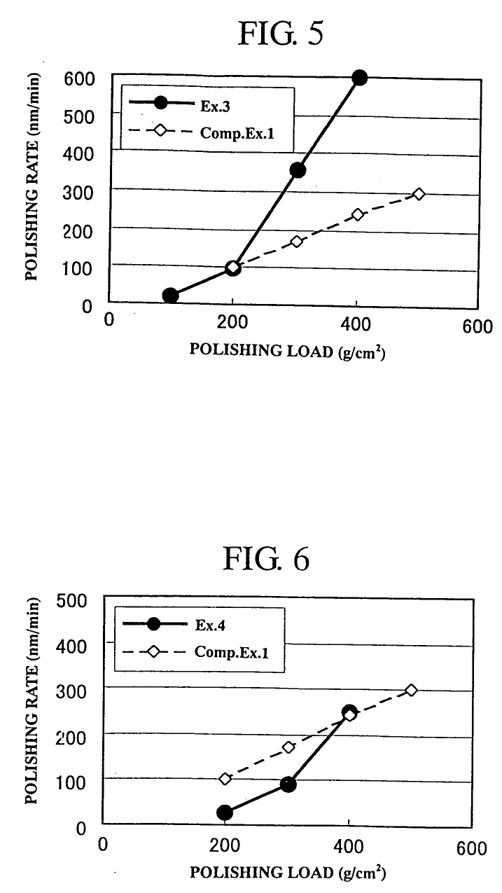

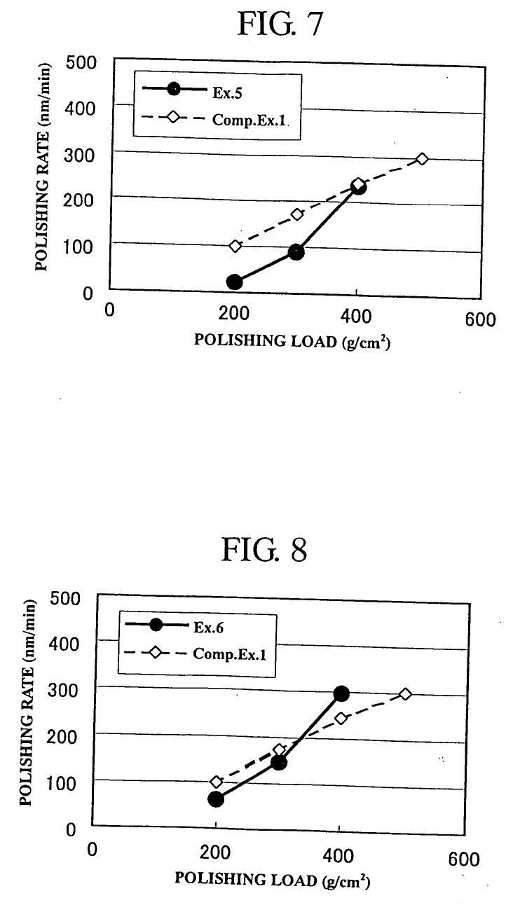

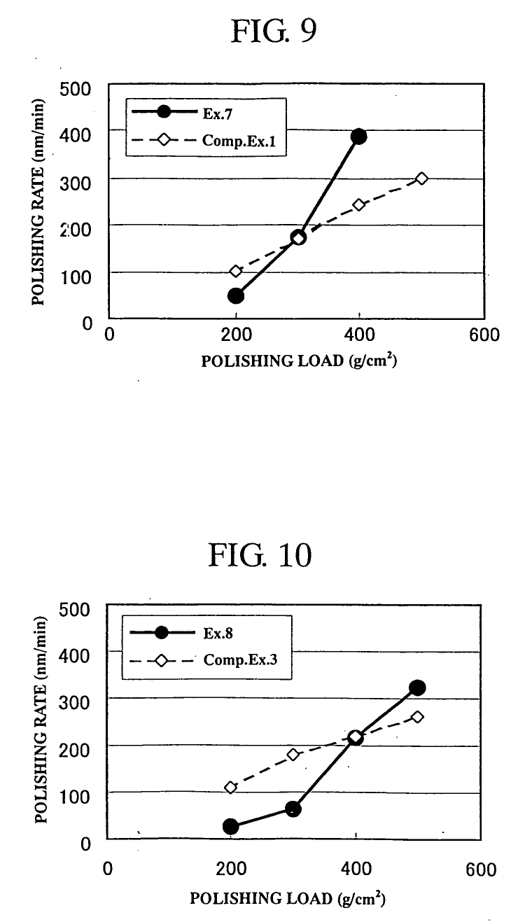

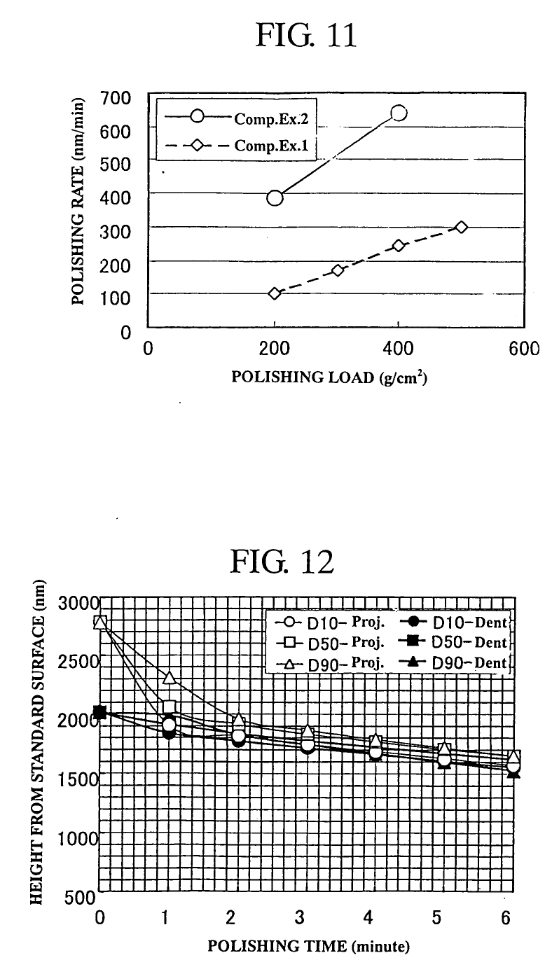

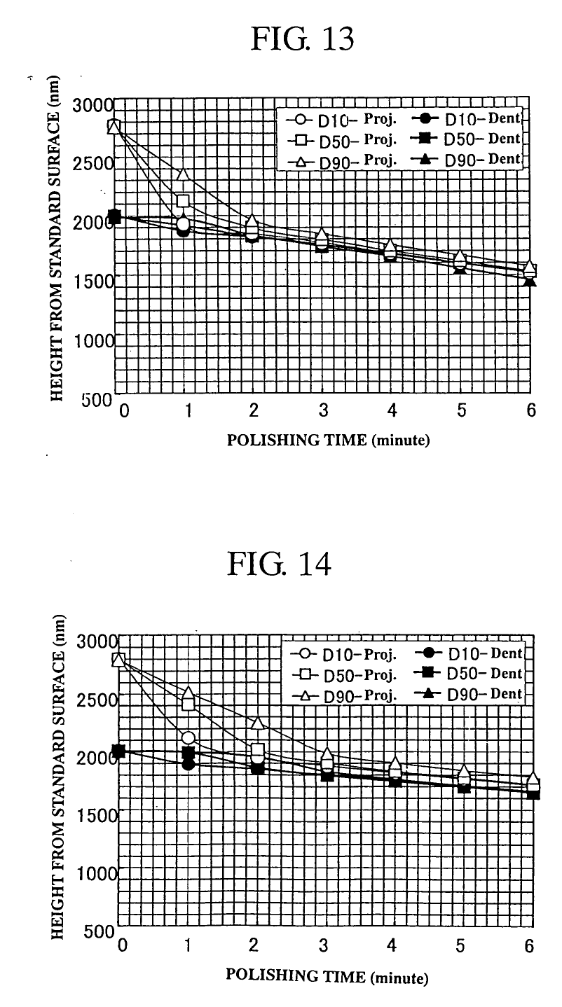

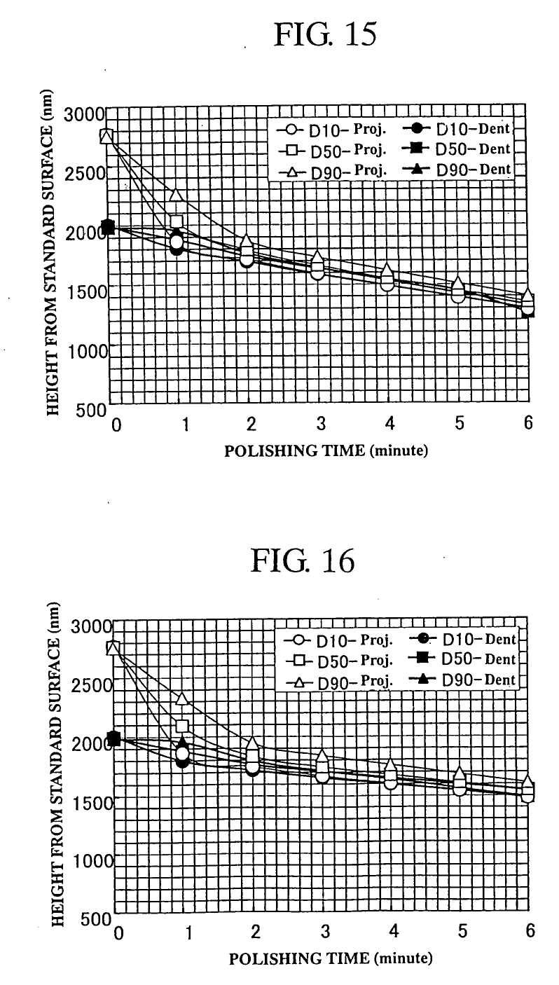

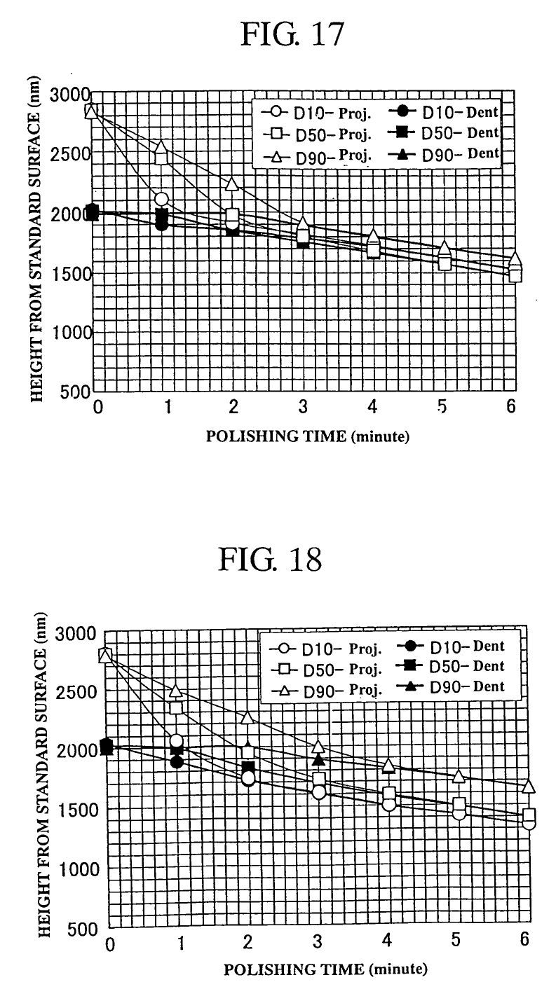

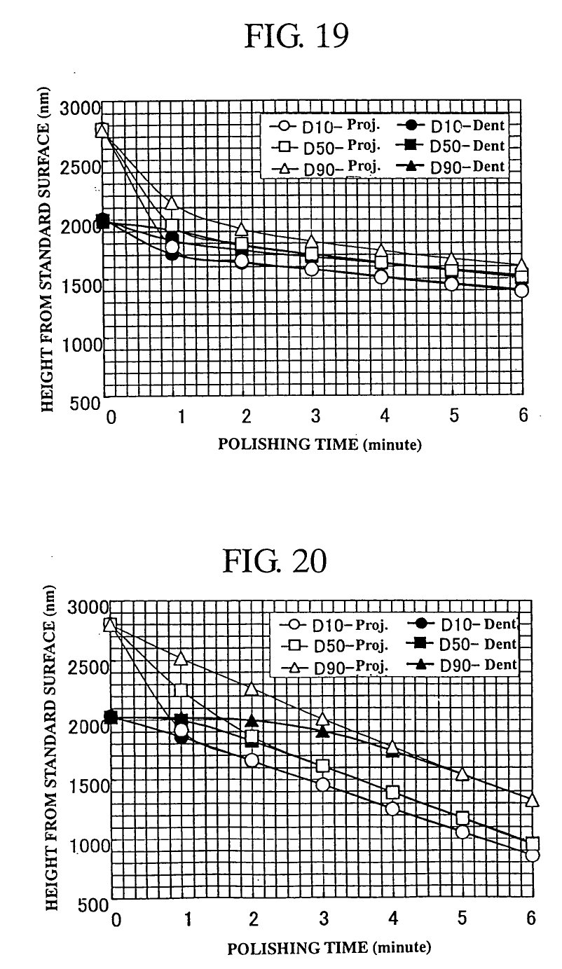

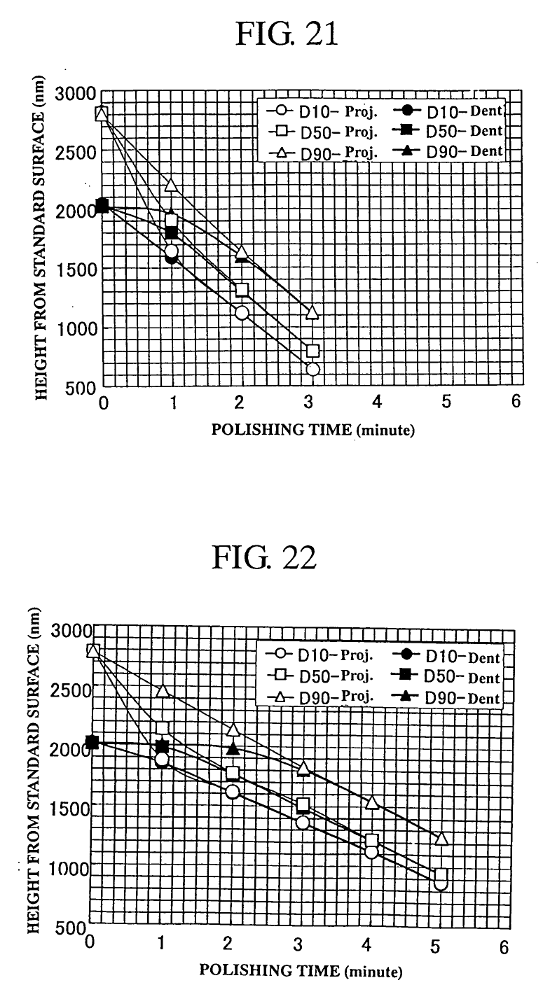

Ex. No.

| | | | | | | | | |
|---|---|---|---|---|---|---|---|---|
| Ex. 1 | (1) | 20% | (a) | 2% | i | 2.3% | with critical point | 300 g/cm² |
| | | | | | | | (FIG. 3) | (FIG. 12) |
| Ex. 2 | (1) | 20% | (a) | 2% | ii | 2.8% | with critical point | 300 g/cm² |
| | | | | | | | (FIG. 4) | (FIG. 13) |
| Ex. 3 | (1) | 20% | (a) | 2% | ii | 2.0% | with critical point | 300 g/cm² |
| | | | | | | | (FIG. 5) | (FIG. 14) |
| Ex. 4 | (1) | 20% | (a) | 2% | iii | 2.4% | with critical point | 300 g/cm² |
| | | | | | | | (FIG. 6) | (FIG. 15) |
| Ex. 5 | (1) | 20% | (a) | 2% | iv | 1.1% | with critical point | 300 g/cm² |
| | | | | | | | (FIG. 7) | (FIG. 16) |
| Ex. 6 | (1) | 20% | (c) | 2% | v | 0.7% | with critical point | 250 g/cm² |
| | | | | | | | (FIG. 8) | (FIG. 17) |
| Ex. 7 | (1) | 20% | (a) | 2% | vi | 6.0% | with critical point | 250 g/cm² |
| | | | | | | | (FIG. 9) | (FIG. 18) |
| Ex. 8 | (2) | 13% | (b) | 1% | i | 0.5% | with critical point | 300 g/cm² |
| | | | | | | | (FIG. 10) | (FIG. 19) |
| Comp. | | | | | | | | |
| Ex. No. | | | | | | | | |
| Comp. | (1) | 20% | — | — | — | — | with no critical point | 300 g/cm² |
| Ex. 1 | | | | | | | | (FIG. 20) |
| Comp. | (1) | 20% | (a) | 2% | — | — | with no critical point | 300 g/cm² |
| Ex. 2 | | | | | | | (FIG. 11) | (FIG. 21) |
| Comp. | (2) | 13% | — | — | — | — | with no critical point | 300 g/cm² |
| Ex. 3 | | | | | | | | (FIG. 22) |

<Polishing Results of Blanket Wafer>

In the polishing of the blanket wafer with the polishing composition of each Example and Comparative Example of Table 3, the relationship of the polishing load and the polishing rate is shown in FIGS. 4 to 11. For the sake of comparison, in FIGS. 4 to 9 and 11, the results of polishing with the polishing composition of Comparative Example 1 are also shown, and in FIG. 10, the results of polishing with the polishing composition of Comparative Example 3 are also shown. In each of the polishing compositions, the polishing rate at a low load was suppressed, and a high polishing rate was exhibited at a higher load, so that there was obtained a critical point in the relationship of the polishing load and the polishing rate. On the other hand, in the polishing composition of Comparative Example 2 containing silica particles and polymer particles, no critical point was obtained.

<Polishing Results of Patterned Wafer>

In the polishing of the patterned wafer in which polishing was carried out with each of the polishing compositions of Examples 2 to 8 and Comparative Examples 1 to 3 of Table 3 at a set polishing load shown in Table 3, a height from the standard surface of the dent portion and the projection portion, i.e. change with the passage of time with the progress of polishing is shown in FIGS. 13 to 22. As compared to the results (FIG. 20 or 22) of polishing with the polishing composition of Comparative Example 1 or 3 in which the polymer particles and the cationic compound are not formulated, it can be seen that 1) the height of the projection portion (thickness) is more quickly reduced at an early stage of polishing of a polishing time of 1 to 2 minutes, and that 2) the polishing of the projection portion is progressed, and the progress of the polishing in both the projection portion and the dent portion is lowered at a point where there is little difference in height of the dent portion with that of the dent portion (step height), thereby controlling the difference in height of the projection portion between the patterns to a low value. Like in Example 1, each of the polishing compositions has a high initial polishing rate at the projection portion, so that the planarization efficiency is high. Further, after the progress of the planarization, the progress of the polishing at both of the projection portion and the dent portion is lowered, thereby making it less likely to be dependent upon the dent and projection patterns. Therefore, it can be seen that a high level of planarization can be achieved. On the other hand, when polished with the polishing composition of Comparative Example 2 in which the silica particles and the polymer particles are formulated, there is a considerable difference in height from the standard surface depending upon the patterns because the polishing is progressed even after there is no difference in height between the dent portion and the projection portion (step height), even though the height of dent portion is rapidly reduced. Therefore, it can be seen that a step height depending upon the patterns is generated.

### Example 9 and Comparative Example 4

The polishing composition obtained in Example 1 was used as a polishing liquid A.

Next, 40 parts of an aqueous dispersion of colloidal silica (commercially available from Du Pont Kabushiki Kaisha under the trade name of Syton OX-K50, solid ingredient: 50%, average particle size: 40 nm) was added to 60 parts by weight of ion-exchanged water with stirring. The pH of the polishing composition was adjusted with an aqueous potassium hydroxide to 10.5 to 11.5 as occasion demands, to give a polishing liquid B used in Example 9.

Finally, 52 parts of a commercially available fumed silica polishing liquid (commercially available from Cabot Microelectronics Corporation under the trade name of SEMI-SPERSE 25, average particle size: 140 nm was added to 48 parts by weight of ion-exchanged water with stirring, to give a polishing liquid used in Comparative Example 4.

The polishing test was conducted under the following conditions with each of the polishing liquid prepared above, and evaluated. Here, the evaluation method was carried out in the same manner as in Example 1.

<Polishing Conditions>

Polishing testing machine: LP-541 (platen diameter: 540 mm), commercially available from Lap Master SFT

Polishing pad: IC-1000/Suba 400 (commercially available from RODEL NITTA).

Platen rotational speed: 60 r/min

Carrier rotational speed: 61 r/min

Feed rate of polishing liquid: 200 (g/min)

Polishing load: 196 to 490 (hPa) [1 g/cm²=0.98 hPa]

<Polishing Results for Patterned Wafer>

In Example 9, the patterned wafer was polished for a total of 4 minutes, a first step with the polishing liquid A for 3 minutes, and thereafter a second step with the polishing liquid B for 1 minute. On the other hand, in Comparative Example 4, the patterned wafer was polished for 4 minutes. In each case, a polishing load of 294 hPa was applied.

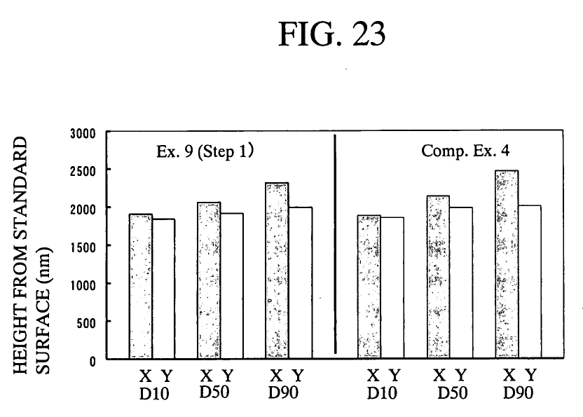

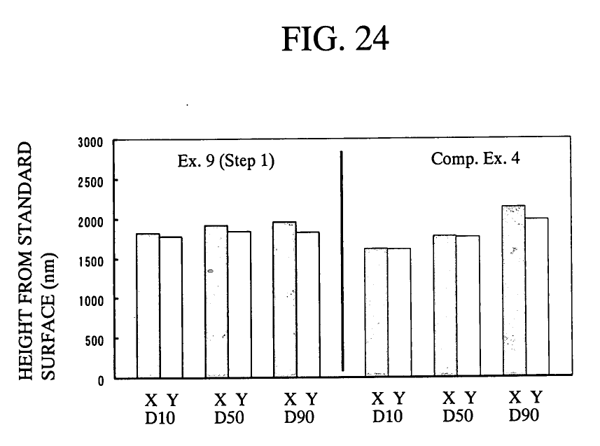

Processes for planarization in which the heights to the standard surface of the projection portion and the dent portion and the step height changes in accordance with the progress of polishing are shown in FIGS. 23 to 26. Although both Example 9 and Comparative Example 4 are progressed in almost the same manner until after one minute of polishing (FIG. 23), when the polishing time reaches after 2 minutes (FIG. 24), there are some noticeable variance in height between the patterns in Comparative Example 4, especially between the patterns of D10 and D90, so that it can be seen that there are newly caused a step height between the patterns. On the other hand, the variance in the height between the patterns in Example 9 is relatively small.

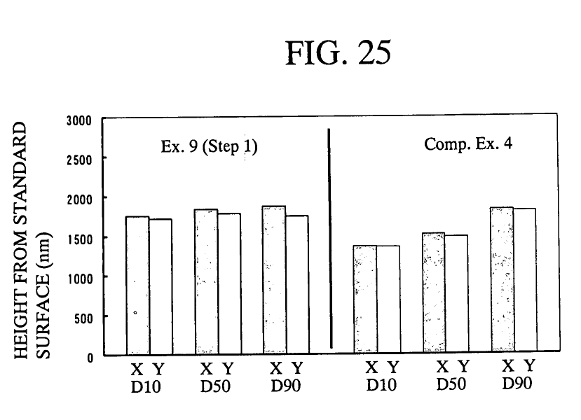

Further, in the polishing after 3 minutes (FIG. 25), in Comparative Example 4, excessive polishing is noticeable because the polishing is continued to progress in addition to the variance in height between the patterns, and especially the height of D10 is noticeably reduced. On the other hand, in Example 9, the excessive polishing is suppressed because the polishing is not progressed at the same time as the reduction in step height, and the variance of the height between the patterns maintained to be small. In Example 9, the polishing process is moved on to the second step at this stage in which the polishing liquid is changed to the polishing liquid B.

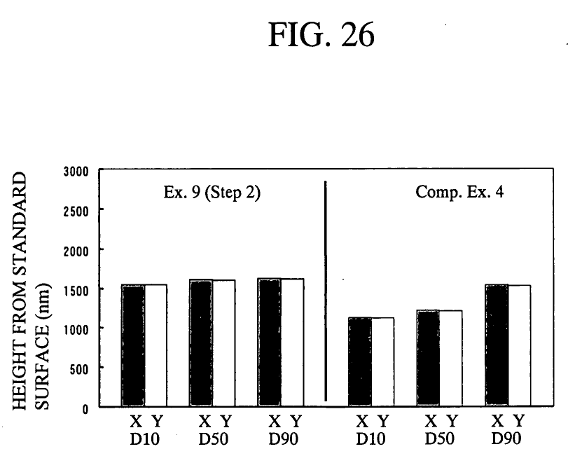

Finally, it can be seen that at 1 minute after the second step (FIG. 26) of Example 9 (or 4 minutes after in Comparative Example 4) in Comparative Example 4 that the heights between the patterns greatly differ even though the planarization is completed in each of the patterns, so that a new step height is remained between the patterns, whereby the achievement of a high level of the planarization is incomplete.

On the other hand, it can be seen in Example 9 that the planarization is accomplished in both within the patterns or between the patterns by carrying out polishing for a total of 4 minutes, the same length as that of Comparative Example 4, so that a high level of the planarization is realized. Also, it can be seen in Example 9 that since excessive polishing is not carried out and a layer to be polished having a sufficient thickness is stored, polishing can be carried out to give patterns having various thicknesses by the treatment in the after treatment.

The polishing composition of the present invention can realize planarization efficiently and at a high level of a surface to be polished having dents and projections. By using the polishing composition, there can be provided a polishing process using this polishing composition and a method for manufacturing a semiconductor device including the step of polishing a semiconductor substrate using the polishing process.

What is claimed is:

1. A polishing composition comprising silica particles, polymer particles and a cationic compound in an aqueous medium.

2. The polishing composition according to claim 1, wherein the silica particles are colloidal silica particles.

3. The polishing composition according to claim 1, wherein the cationic compound is at least one member selected from the group consisting of amine compounds, quaternary ammonium salt compounds, betain compounds and amino acid compounds.

4. The polishing composition according to claim 2, wherein the cationic compound is at least one member selected from the group consisting of amine compounds, quaternary ammonium salt compounds, betain compounds and amino acid compounds.

5. The polishing composition according to claim 1, wherein the polymer particles comprise particles made of a thermoplastic resin having a glass transition temperature of 200° C. or less.

6. The polishing composition according to claim 2, wherein the polymer particles comprise particles made of a thermoplastic resin having a glass transition temperature of 200° C. or less.

7. The polishing composition according to claim 3, wherein the polymer particles comprise particles made of a thermoplastic resin having a glass transition temperature of 200° C. or less.

8. The polishing composition according to claim 4, wherein the polymer particles comprise particles made of a thermoplastic resin having a glass transition temperature of 200° C. or less.

9. A polishing process for a substrate for a precision part, comprising the step of polishing the substrate for a precision part with the polishing composition as defined in claim 1.

10. A method for planarization of a substrate for a precision part, comprising the step of polishing the substrate for a precision part with the polishing composition as defined in claim 1.

11. A method for planarization of a substrate for a precision part, comprising the following first step and second step:
first step: polishing the substrate for a precision part with the polishing composition as defined in claim 1, said polishing composition being a first polishing composition, with applying a polishing load of 50 to 1000 hPa; and
second step: polishing the substrate after the first step with a second polishing composition comprising silica particles in an aqueous medium with applying a polishing load of 50 to 1000 hPa.

12. A method for manufacturing a substrate for a precision part, comprising the step of polishing a substrate for a precision part with the polishing composition of as defined in claim 1.

13. A method for manufacturing a substrate for a precision part, comprising the following first step and second step:
first step: polishing the substrate for a precision part with the polishing composition as defined in claim 1, said polishing composition being a first polishing composition, with applying a polishing load of 50 to 1000 hPa; and
second step: polishing the substrate after the first step with a second polishing composition comprising silica particles in an aqueous medium with applying a polishing load of 50 to 1000 hPa.

14. The method according to claim 12, wherein the substrate is a substrate in which at least a film containing silicon is formed on a surface to be polished.

15. The method according to claim 13, wherein the substrate is a substrate in which at least a film containing silicon is formed on a surface to be polished.

16. A semiconductor device comprising a substrate for a precision part obtained by the method as defined in claim 12.

17. A semiconductor device comprising a substrate for a precision part obtained by the method as defined in claim 13.
